(19) United States
(12) Patent Application Publication
(10) Pub. No.: US 2012/0130635 A1
(43) Pub. Date: May 24, 2012

(54) PORTABLE INFORMATION TERMINAL APPARATUS AND COMPUTER PROGRAM PRODUCT

(75) Inventors: Mahina Nakamura, Tokyo (JP); Maki Sato, Kanagawa (JP); Yumiko Okuma, Tokyo (JP); Tsunehiro Motegi, Tokyo (JP)

(73) Assignee: TOSHIBA TEC KABUSHIKI KAISHA, Tokyo (JP)

(21) Appl. No.: 13/297,418

(22) Filed: Nov. 16, 2011

(30) Foreign Application Priority Data
Nov. 18, 2010 (JP) 2010-258234

(51) Int. Cl. G01C 21/00

(52) U.S. Cl. 701/465; 701/527; 701/526

(57) ABSTRACT

A portable information terminal apparatus according to an embodiment acquires route point information corresponding to advertisement information displayed on a digital signage terminal apparatus and searches for a guidance route including a route point equivalent to the acquired route point information. Therefore, in a building such as a shopping mall, it is possible to easily guide, without increases labor of a customer as a user, the customer to a store or the like in which the customer takes an interest according to the advertisement information.

### CROSS-REFERENCE TO RELATED APPLICATION

This application is based upon and claims the benefit of priority from Japanese Patent Application No. 2010-258234 filed on Nov. 18, 2010; the entire contents of which are incorporated herein by reference.

### FIELD

Embodiments described herein relate generally to a portable information terminal apparatus and a computer program product.

### BACKGROUND

In the past, there is known a system that generates, according to the operation by a user, a tour route for guiding the user to facilities that the user desires to visit in a commercial facility such as a shopping mall, an underground shopping area, or the like.

If a customer is walking in an actual building such as a shopping mall, the customer sometimes catches sight of an advertisement presented by a paper medium or a digital signage terminal apparatus in various places and takes an interest in a commodity of the advertisement and a store that sells the commodity.

If a target of such an advertisement is a commodity or a store present in front of the customer, the customer can easily pick up the commodity or visits the store. However, if the commodity or the store is present in a location apart from the advertisement even on the same floor or located in another floor, the customer cannot easily pick up the commodity or visit the store.

In particular, if the customer already determines a store or the like that the customer desires to visit, the customer finds it annoying to take the trouble to search for such a commodity or a store.

### DESCRIPTION OF THE DRAWINGS

FIG. 1 is a schematic configuration block diagram of an information processing system according to an embodiment;

FIG. 2 is an external front view of a digital signage terminal apparatus;

FIG. 3 is a schematic configuration block diagram of the digital signage terminal apparatus;

FIG. 4 is a schematic configuration block diagram of a portable information terminal apparatus;

FIG. 5 is an explanatory diagram of a display screen of the portable information terminal apparatus;

FIG. 6 is a flowchart of processing of the portable information terminal apparatus performed if a route point is added;

FIG. 7 is a schematic explanatory diagram of a state in which the portable information terminal apparatus acquires advertisement information for addition of a route point from the digital signage terminal apparatus;

FIG. 8 is an explanatory diagram of a state in which advertisement information including time information is displayed on a display unit of the digital signage terminal apparatus;

FIG. 9 is a flowchart of processing performed if an hour is drawing near when a user should pass through a route point, a time slot or an hour when the user should pass through which cannot be shifted;

FIGS. 10A to 10C are explanatory diagrams of a setting state of a guidance route;

FIG. 11 is an explanatory diagram of a guidance route in an initial state;

FIG. 12 is an explanatory diagram of a guidance route set if time slot information is not included in information concerning a route point that should be added;

FIG. 13 is an explanatory diagram of a guidance route set if time slot information is included in the information concerning the route point that should be added;

FIG. 14 is a schematic configuration block diagram of an information processing system according to another embodiment; and

FIG. 15 is a timing chart of processing by a portable information terminal apparatus 13 and a route search server 16 performed when a route point is added.

### DETAILED DESCRIPTION

In general, according to one embodiment, a portable information terminal apparatus includes an information acquiring unit. The information acquiring unit acquires route point information corresponding to advertisement information displayed on an advertisement information delivery terminal apparatus.

A route search unit searches for a guidance route including a set route point and a route point equivalent to the route point information acquired by the information acquiring unit.

A route guidance unit performs route guidance on the basis of the guidance route.

In general, according to another embodiment, a portable information terminal apparatus includes an information acquiring unit. The information acquiring unit acquires route point information corresponding to advertisement information displayed on an advertisement information delivery terminal apparatus and including location information of a route point and information concerning an arrival recommended hour when arrival at the route point is recommended.

A route search unit searches for a guidance route including a set route point and a route point equivalent to the route point information acquired by the information acquiring unit such that a user arrives at, at the arrival recommended hour, a route point corresponding to the information concerning the arrival recommended hour.

A route guidance unit performs route guidance on the basis of the guidance route.

In general, according to still another embodiment, a computer program product is a computer program product including a computer-readable recording medium including plural commands for performing a route guidance operation that can be executed by a computer.

The plural commands cause the computer to execute an information acquiring operation for acquiring route point information corresponding to advertisement information displayed on an advertisement information delivery terminal apparatus and a route searching operation for searching for a guidance route including a route point equivalent to the acquired route point information.

A portable information terminal apparatus according to an embodiment is explained in detail with reference to the accompanying drawings.

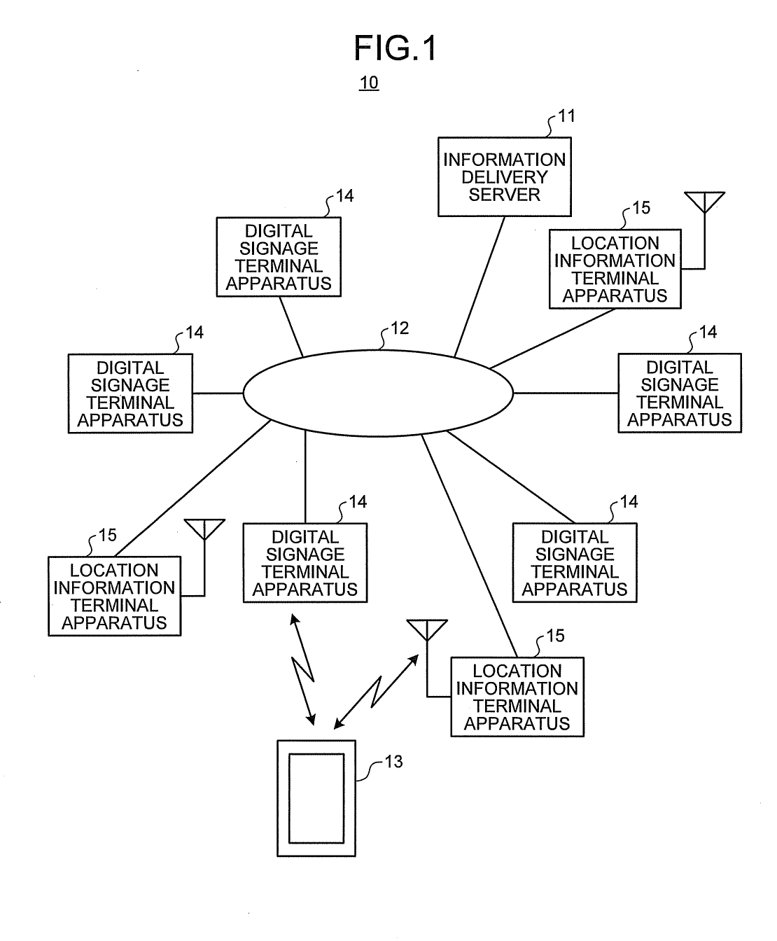

FIG. 1 is a schematic configuration block diagram of an information processing system including a portable information terminal apparatus according to the embodiment.

In the following explanation, the information processing system including the portable information terminal apparatus according to this embodiment is provided in a shopping mall.

The information processing system 10 includes an information delivery server 11, a communication network 12, a portable information terminal apparatus 13, plural digital signage terminal apparatuses 14, and plural location information terminal apparatuses 15.

The information delivery server 11 delivers advertisement information of a commodity and information concerning an event.

The portable information terminal apparatus 13 displays the advertisement information and the event information delivered from the information delivery server 11 via the communication network 12 such as a LAN. The portable information terminal apparatus 13 is carried by a customer of a shopping mall.

The digital signage terminal apparatus 14 delivers information related to information such as advertisement information and event information to the portable information terminal apparatus 13.

The location information terminal apparatus 15 notifies, through wireless communication, the portable information terminal apparatus 13 of location specifying information for specifying the location of the portable information terminal apparatus 13.

In the configuration explained above, as the communication network 12, both a wired communication network and a wireless communication network can be applied.

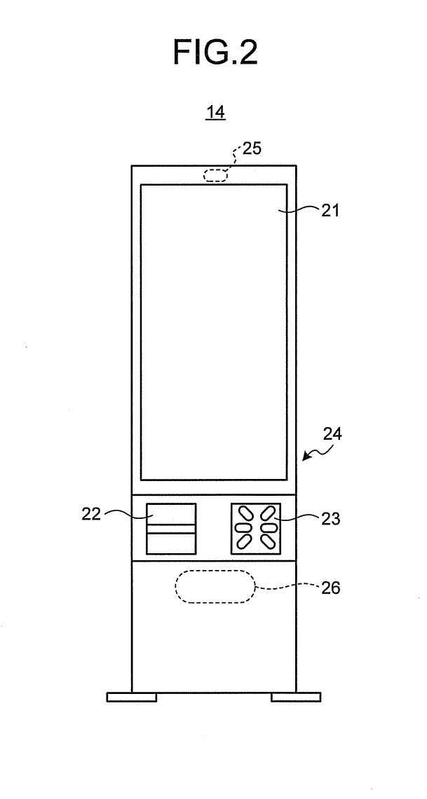

FIG. 2 is an external front view of the digital signage terminal apparatus.

The digital signage terminal apparatus 14 includes a display unit 21 configured as a liquid crystal display or a plasma display, a printer unit 22 configured to print and issue various tickets, coupons, and the like, a short-range wireless communication section 23 configured to perform communication with the portable information terminal apparatus 13 through short-range wireless communication in a communication distance of about several centimeters to 10 centimeters, and a housing section 24 configured to support the display unit 21, the printer unit 22, and the short-range wireless communication section 23.

As the printer unit 22, for example, a printer apparatus of a thermal recording system that uses roll paper as a recording medium is used. The printer unit 22 includes a cut mechanism configured to automatically cut the roll paper according to necessity.

A camera unit 25 and a speaker unit 26 are incorporated in an upper part of the housing section 24.

The camera unit 25 is used for, for example, photographing a user, performing image recognition, specifying an age group of the user, and controlling a type of information to be delivered. It is also possible to perform processing of the image recognition and the like on an upstream side server such as the information delivery server 11 without performing the processing in the digital signage terminal apparatus 14.

The speaker unit 26 performs various acoustic outputs of BGM, advertisement sound, and the like.

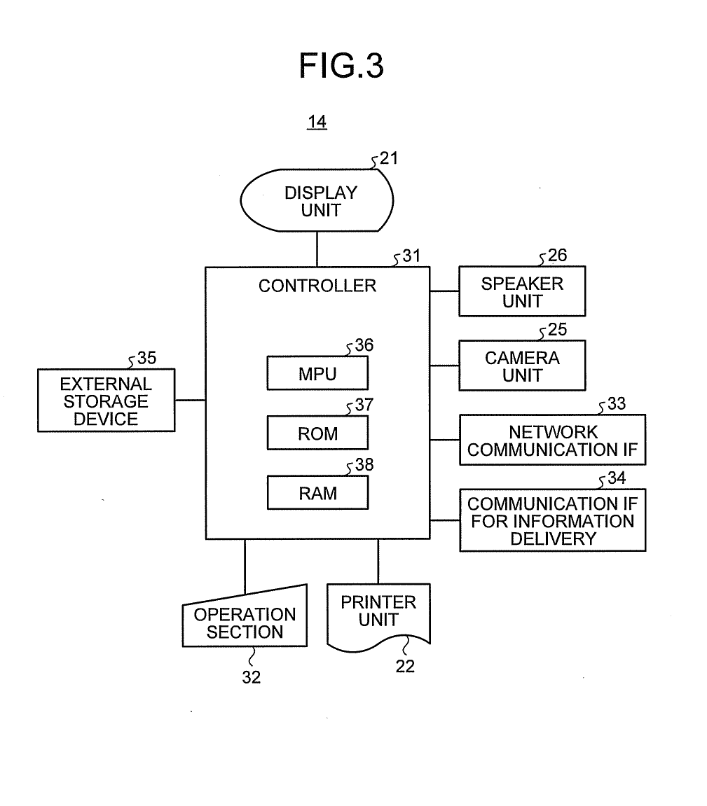

FIG. 3 is a schematic configuration block diagram of the digital signage terminal apparatus.

The digital signage terminal apparatus 14 includes a controller 31, an operation section 32, a network communication interface (IF) 33, a communication interface (IF) for information delivery 34, and an external storage device 35 besides the display unit 21, the printer unit 22, the camera unit 25, and the speaker unit 26.

The controller 31 controls the entire digital signage terminal apparatus 14. The controller 31 includes an MPU 36 configured to control the entire controller 31, a ROM 37 storing therein a control program and the like for the MPU 36 to operate, and a RAM 38 configured to temporarily store various data.

An operator or a user performs various kinds of operation using the operation section 32. The operation section 32 can include various switches, buttons, and the like or can be configured as a touch panel integrally with the display unit 21 such as a liquid crystal display.

The network communication interface (IF) 33 performs communication between the digital signage terminal apparatus 14 and the information delivery server 11 via the communication network 12.

The communication interface (IF) for information delivery 34 configures the short-range wireless communication section 23 and delivers information related to information such as advertisement information and event information to the portable information terminal apparatus 13. The communication interface (IF) for information delivery 34 performs, using, for example, a frequency of 13.56 MHz, a communication interface operation of a short-range wireless communication system in a communication distance of about several centimeters to 10 centimeters. When the information related to information such as advertisement information and event information is delivered to the portable information terminal apparatus 13, besides the communication via the communication interface (IF) for information delivery 34, it is also possible to configure the digital signage terminal apparatus 14 to deliver the information by displaying, for example, a two-dimensional barcode on a display screen of the display unit 21 and causing a camera of the portable information terminal apparatus 13 to photograph and decode the two-dimensional barcode.

The external storage device 35 stores various data. As the external storage device 35, besides a hard disk device and an SSD (Solid State Drive) device incorporating a flash ROM, a nonvolatile memory such as an EEPROM may be used.

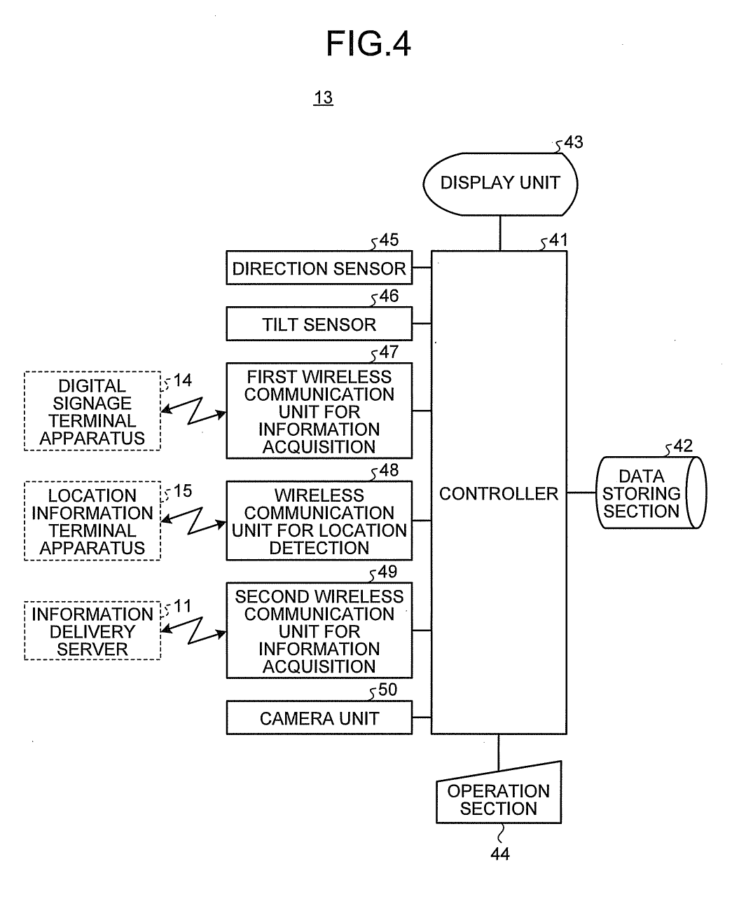

FIG. 4 is a schematic configuration block diagram of the portable information terminal apparatus.

The portable information terminal apparatus 13 roughly includes a controller 41, a data storing section 42, a display unit 43, an operation section 44, a direction sensor 45, a tilt sensor 46, a first wireless communication unit for information acquisition 47, a wireless communication unit for location detection 48, a second wireless communication unit for information acquisition 49, and a camera unit 50.

The controller 41 controls the entire portable information terminal apparatus 13. The controller 41 is configured as a microcomputer including a not-shown MPU configured to control the entire controller 41, a not-shown ROM storing therein a control program and the like for the MPU to operate, and a RAM configured to temporarily store various data. The controller 41 detects the present location of the portable information terminal apparatus 13 on the basis of location information data received from the wireless communication unit for location detection 48. The controller 41 generates a guidance route for a user on the basis of an instruction of the user concerning stores and the like that the user desires to stop by and delivery data (data concerning a recommended route, etc.) acquired from the information delivery server 11 via the second wireless communication unit for information acquisition 49 and referring to information concerning route points such as set stores and spaces (event sites, etc.) where the user stops by (route point information). Further, the controller 41 performs route guidance while presenting the generated guidance route to the user on the basis of detection signals of the direction sensor 45 and the tilt sensor 46.

The data storing section 42 stores various data. As the data storing section 42, a nonvolatile memory such as an EEPROM is conceivable. The data storing section 42 stores various kinds of information such as map data of floors, location information of stores, and event related information (event holding places, event holding periods, etc.). These kinds of information are updated as appropriate under the control by the information delivery server 11.

The display unit 43 performs display of various kinds of information. As the display unit 43, a liquid crystal display consuming small power, color electronic paper not consuming power except display and update time, or the like are desirable.

The operation section 44 is configured as a touch panel integrally with the display unit 43.

The direction sensor 45 includes a terrestrial magnetism sensor or the like and detects a traveling direction of the portable information terminal apparatus 13.

The tilt sensor 46 includes a gyro sensor or the like and detects a tilt (e.g., tilts in triaxial directions) involved in a posture change of the portable information terminal apparatus 13.

The first wireless communication unit for information acquisition 47 performs communication via the communication interface (IF) for information delivery 34 of the digital signage terminal apparatus 14. The first wireless communication unit for information acquisition 47 is a short-range wireless communication apparatus having a communication distance of about several centimeters to 10 centimeters.

The wireless communication unit for location detection 48 receives a location information radio wave from the location information terminal apparatus 15 and outputs location detection data to the controller 41.

The second wireless communication unit for information acquisition 49 performs communication via the information delivery server 11 and the communication network 12. The second wireless communication unit for information acquisition 49 is a wireless communication apparatus having a communication distance of several meters to several tens meters that builds a wireless LAN or the like.

The camera unit 50 acquires an actual photographed image (moving image) for the user to display route guidance information or the like to be superimposed on the actual photographed image. The camera unit 50 reads information of a two-dimensional barcode or the like displayed on the display screen of the display unit 21 of the digital signage terminal apparatus 14. The camera unit 50 includes a CCD or CMOS image sensor. The camera unit 50 photographs a color image as a still image or a moving image.

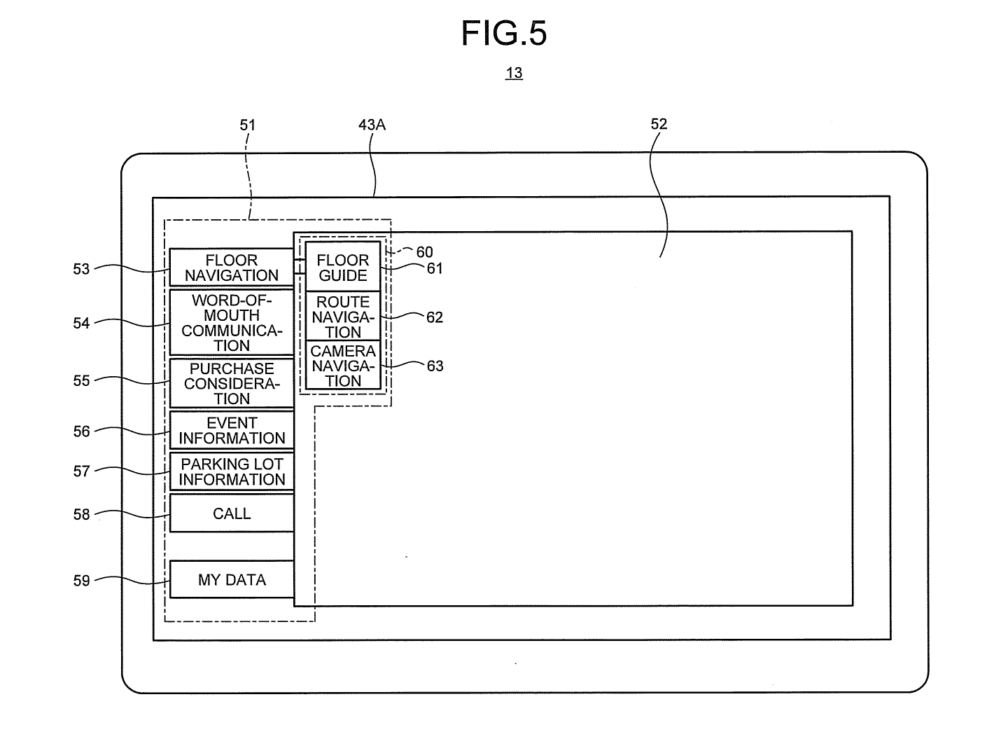

FIG. 5 is an explanatory diagram of a display screen of the portable information terminal apparatus.

The portable information terminal apparatus 13 can be used in both lengthwise and sideways according to an operation mode or a taste (an instruction) of the user. FIG. 5 is a diagram of an example of a display screen of the portable information terminal apparatus 13 used sideways.

A display screen 43A of the display unit 43 of the portable information terminal apparatus 13 roughly includes a menu display operation area 51 and an image display area 52.

The menu display operation area 51 includes a floor navigation selection button 53, a word-of-mouth communication selection button 54, a purchase consideration selection button 55, an event information selection button 56, a parking lot information selection button 57, a call selection button 58, and a my data button 59.

The floor navigation selection button 53 is used to shift to a floor navigation mode for causing the portable information terminal apparatus 13 to perform floor guide of floors of a shopping mall (guidance of store arrangement, etc.) and route guidance (navigation) in the shopping mall.

The word-of-mouth communication selection button 54 is used to refer to word-of-mouth communication information in the shopping mall. The word-of-mouth communication selection button 54 is used in shifting to a word-of-mouth communication mode for posting word-of-mouth communication information.

The purchase consideration selection button 55 is used to shift to a purchase consideration mode for considering purchase of a commodity in the shopping mall.

The event information selection button 56 is used to shift to an event information mode for displaying information concerning an event held in the shopping mall, an event being held, or an event scheduled to be held.

The parking lot information selection button 57 is used to shift to a parking lot information mode for displaying information concerning a parking lot of the shopping mall such as the arrangement of parking spaces.

The call selection button 58 is used to shift to a call mode for calling an accompanying person who carries the portable information terminal apparatus 13 in the shopping mall.

The my data button 59 is used to display, for example, information registered in advance by the user.

When the user touches each of the buttons 53 to 59 to thereby perform selection operation, if a sub-mode, which is a low order mode belonging to a selected mode, is present, one or plural sub-mode selection buttons corresponding to the sub-mode are displayed in a sub-mode display area 60 adjacent to the touched button.

FIG. 5 is a diagram of sub-mode selection buttons displayed if the user touches the floor navigation selection button 53.

In the floor navigation mode, a floor guide sub-mode selection button 61, a route navigation sub-mode selection button 62, and a camera navigation sub-mode selection button 63 are displayed as the sub-mode selection buttons.

The floor guide sub-mode selection button 61 is used to display a guidance screen including stores arranges in the respective floors and map images.

The route navigation sub-mode selection button 62 is used to display a guidance screen for performing route guidance in the shopping mall on the basis of, for example, stop-by destinations registered by the user and recommended stop-by information delivered by the information delivery server 11.

The camera navigation sub-mode selection button 63 is used to display a guidance screen for displaying, on the basis of image data received from the information delivery server 11, in a form of seeing through another floor located within a photographing angle of view, an image indicating arrangement locations of facilities on the other floor and information concerning the other floor while superimposing the image and the information on a photographed screen, which is photographed by the camera unit 50, on a real time basis.

As explained above, the operation modes of the portable information terminal apparatus 13 adopt a hierarchical structure. If a lower order sub-mode is present under a sub-mode, when the user touches the sub-mode selection button, a lower order sub-mode selection button belonging to the sub-mode is displayed.

In the following explanation, the route navigation sub-mode selection button 62 is selected in the floor navigation mode and the portable information terminal apparatus 13 operates in a route navigation mode.

First, an operation performed if a route point added to a guidance route is added to the portable information terminal apparatus 13 from the digital signage terminal apparatus 14 in the route navigation mode is explained.

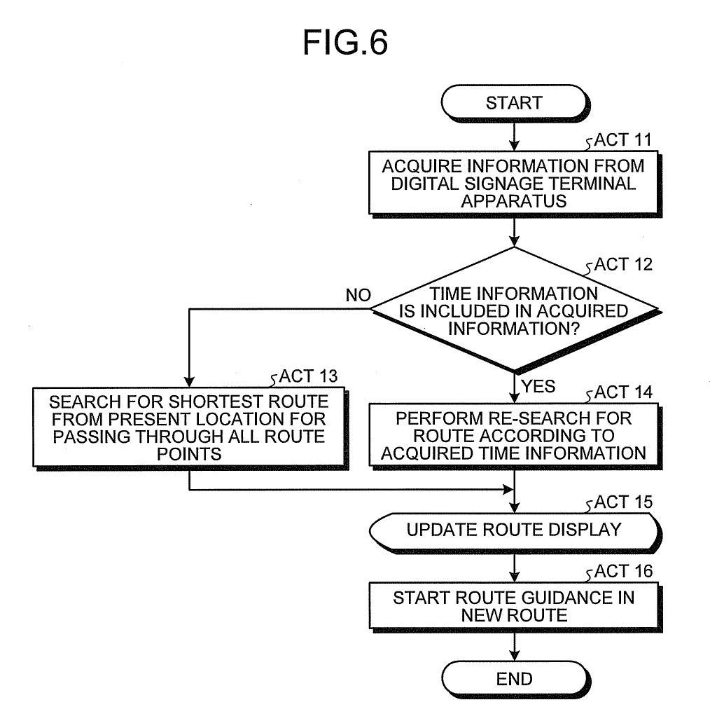

FIG. 6 is a flow chart of processing of the portable information terminal apparatus 13 performed if a route point is added.

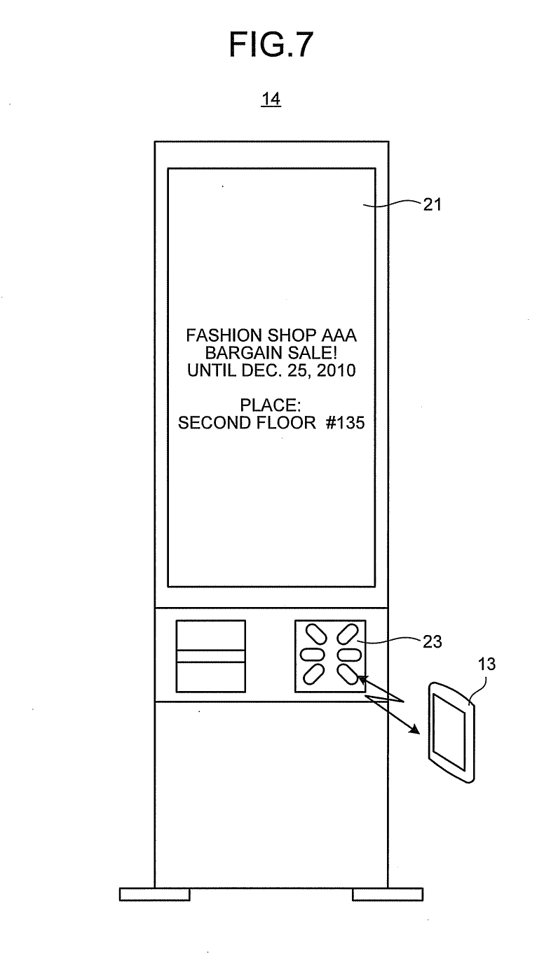

FIG. 7 is a schematic explanatory diagram of a state in which the portable information terminal apparatus 13 acquires advertisement information for addition of a route point from the digital signage terminal apparatus 14.

As shown in FIG. 7, in a state in which the user sees and takes an interest in an advertisement and desired advertisement information including information concerning a commodity corresponding to the advertisement or a store dealing in the commodity is displayed on the display unit 21 of the digital signage terminal apparatus 14, if the user brings the portable information terminal apparatus 13 close to a communicable range of the short-range wireless communication section 23, information concerning a route point (the commodity, the place of the store, a place where an event is held, etc.) related to the advertisement information is transmitted to the portable information terminal apparatus 13. The transmitted information concerning the route point related to the advertisement information is received by the portable information terminal apparatus 13 using the first wireless communication unit for information acquisition 47.

In the case of an example shown in FIG. 7, the portable information terminal apparatus 13 receives and acquires information indicating the location of a store “Fashion shop AAA” (Act 11).

Specifically, information for specifying an arrangement place of the location information terminal apparatus 15 equivalent to #135 on the second floor of the shopping mall and the location information terminal apparatus 15 is transmitted.

Subsequently, the controller 41 of the portable information terminal apparatus 13 discriminates whether time information (hour information or time slot information), which is information concerning an hour or a time slot when the user should arrive at the route point, is included in the acquired information concerning the route point (Act 12).

If an advertiser is an operator of the store, the time information is included in the information concerning the route points in order to increase customer attraction by providing a limit on, for example, a time slot for time-limited sales and time for distribution of numbered tickets. If the advertiser is an event sponsor, since an event itself is not held forever, the time information is included in the information concerning the route points in order to attract customers only in date and time when the event is actually held.

If time information is not included in the acquired advertisement information in the discrimination in Act 12 (No in Act 12), the controller 41 of the portable information terminal apparatus 13 searches for, as a new guidance route, a shortest route from a present location for passing through all route points including the added route point (Act 13).

The controller 41 performs display update (route display update) for a guidance route in order to display an obtained guidance route on the display unit 43 (Act 15). Further, the controller 41 starts route guidance in the new guidance route (Act 16).

On the other hand, if time information is included in the acquired advertisement information in the discrimination in Act 12 (Yes in Act 12), the controller 41 performs re-search for a guidance route according to the acquired time information such that the user can arrive at or stay at an added route point at an hour or a time slot corresponding to the time information (Act 14).

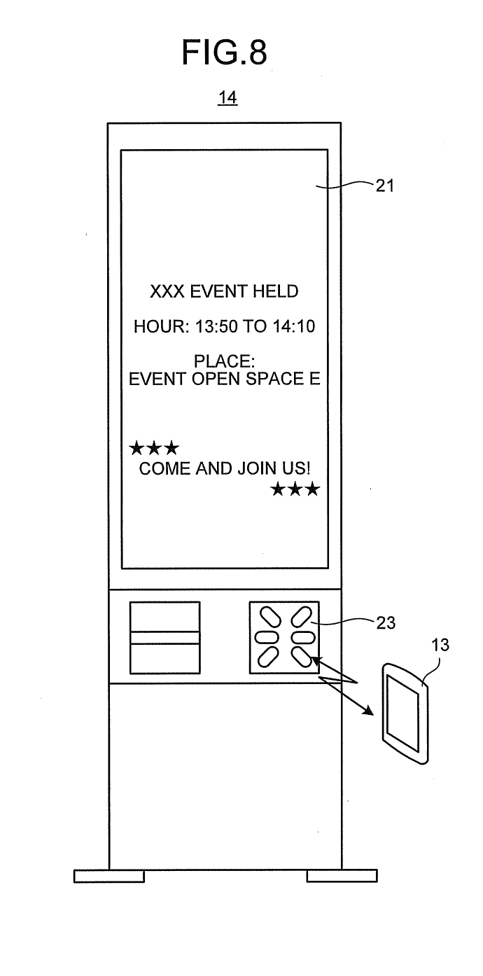

FIG. 8 is an explanatory diagram of a state in which advertisement information including time information is displayed on the display unit 21 of the digital signage terminal apparatus 14.

As shown in FIG. 8, if the user brings the portable information terminal apparatus 13 close to the communicable range of the short-range wireless communication section 23, information concerning route points related to the advertisement information and including the time information is transmitted to and received by the portable information terminal apparatus 13.

In the case of an example shown in FIG. 8, the portable information terminal apparatus 13 receives and acquires information indicating the location of an “event open space E”, which is a holding place of a “xxx event” to be held and time information representing a holding time slot “13:50 to 14:10” (Act 11).

Subsequently, the controller 41 of the portable information terminal apparatus 13 discriminates whether time information, which is information concerning an hour or a time slot when the user should arrive at the route point, is included in the acquired information concerning the route point (Act 12). More specifically, the controller 41 discriminates that information concerning the holding time slot of the “xxx event” is included.

Therefore, in this case, a shortest route is not always searched for. Therefore, the controller 41 performs re-search for a guidance route such that the user can arrive at the event site, which is the route point, before the time slot or at a time slot early enough for effectively taking part in the event.

The controller 41 performs display update (route display update) for a guidance route in order to display an obtained guidance route on the display unit 43 (Act 15). The controller 41 starts route guidance in the new guidance route (Act 16).

As a result of the processing, the user can surely take part in an event, time-limited sales, or the like, which the user desires to take part in, without worrying about a time slot thereof more than necessary.

In shopping or the like, it is likely that a customer consumes time longer than initially-scheduled time in a store or the like that the customer visits.

In such a case, if the customer visits stores and the like one after another according to an initial guidance route, a situation could occur in which the customer is late for an initially-scheduled event, time-limited sales, or the like.

Therefore, in this embodiment, if time information is included in the advertisement information, concerning a route point, a time slot or an hour when the user should pass through which cannot be shifted (cannot be shifted at all or a tolerance of the shift is small) according to an actual action of the user, the controller 41 performs re-search for a guidance route on the basis of a present hour to allow the user to pass through the route point and enables the user to surely arrive at a designated route point at a designated hour or time slot.

This is explained in detail below.

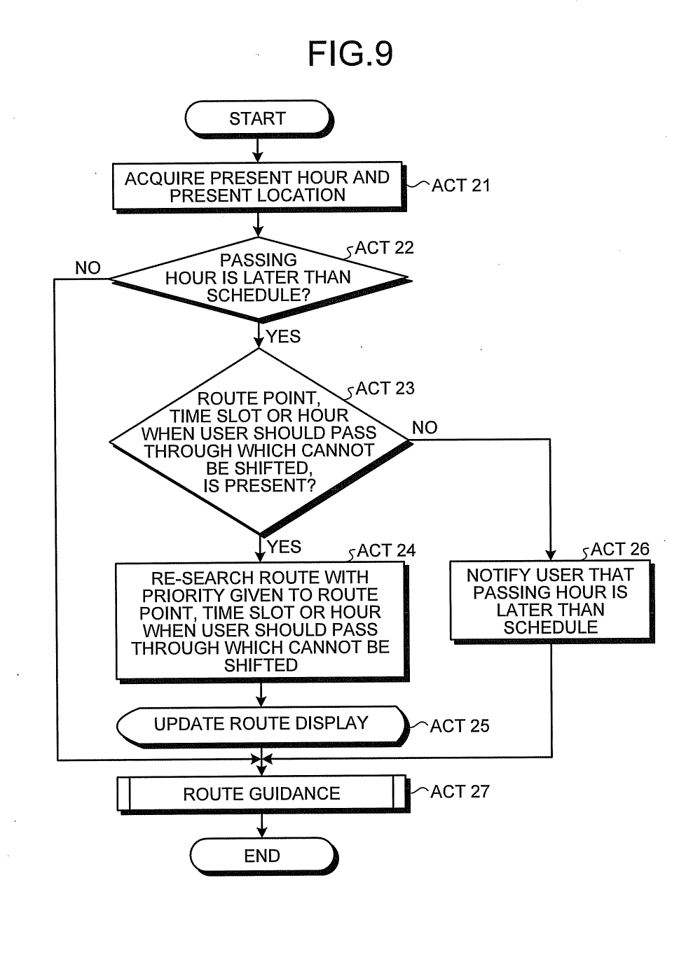

FIG. 9 is a flowchart of processing performed if an hour is drawing near, when a user should pass through a route point, a time slot or an hour when the user should pass through which cannot be shifted.

First, the controller 41 of the portable information terminal apparatus 13 acquires a present hour and a present location (Act 21). The controller 41 acquires the present hour from a not-shown system timer. The controller 41 grasps the present location on the basis of location information acquired from the location information terminal apparatus 15 via the wireless communication unit for location detection 48. In this case, it is assumed that, in an area where the movement of the portable information terminal apparatus 13 is permitted in advance, a relation between location information obtained from the location information terminal apparatus 15 and a location in a facility is clearly set.

The controller 41 discriminates whether a passing hour of the present location of the portable information terminal apparatus 13 is later than a passing scheduled hour of the present location set when the portable information terminal apparatus 13 moves according to a guidance route set in advance (Act 22).

If the passing hour of the present location of the portable information terminal apparatus 13 is not later than the passing scheduled hour in the discrimination in Act 22 (No in Act 22), the controller 41 continues the route guidance without performing the route search again (Act 27).

On the other hand, if the present location of the portable information terminal apparatus 13 is later than the passing scheduled hour in the discrimination in Act 22 (Yes in Act 22), the controller 41 discriminates whether a route point, a time slot or an hour when the user should pass through which cannot be shifted, is included in the following guidance route (Act 23).

If a route point, a time slot or an hour when the user should pass through which cannot be shifted, is not included in the following guidance route in the discrimination in Act 23 (No in Act 23), since a slight delay is allowed, by way of precaution, the controller 41 displays on a display screen of the display unit 43 that the passing hour is later than the passing scheduled hour and notifies the user of the portable information terminal apparatus 13 to that effect (Act 26). The controller 41 continues the route guidance without performing the route search again (Act 27). If the portable information terminal apparatus 13 includes a buzzer or the like, in addition to the display or instead of the display, the controller 41 can notify, with buzzer sound or the like, the user that the passing hour is later than the passing scheduled hour.

If a route point, a time slot or an hour when the user should pass through which cannot be shifted, is included in the following guidance route in the discrimination in Act 23 (Yes in Act 23), the controller 41 re-searches a guidance route such that the user preferentially passes through the route point (Act 24). Subsequently, the controller 41 updates the display of the guidance route in order to display the obtained new guidance route on the display unit 43 (Act 25). The controller 41 performs the route guidance according to the new guidance route (Act 27).

Therefore, even if the user consumes time longer than scheduled time halfway in the guidance route, the user can surely take part in an event and receive benefit of time-limited sales.

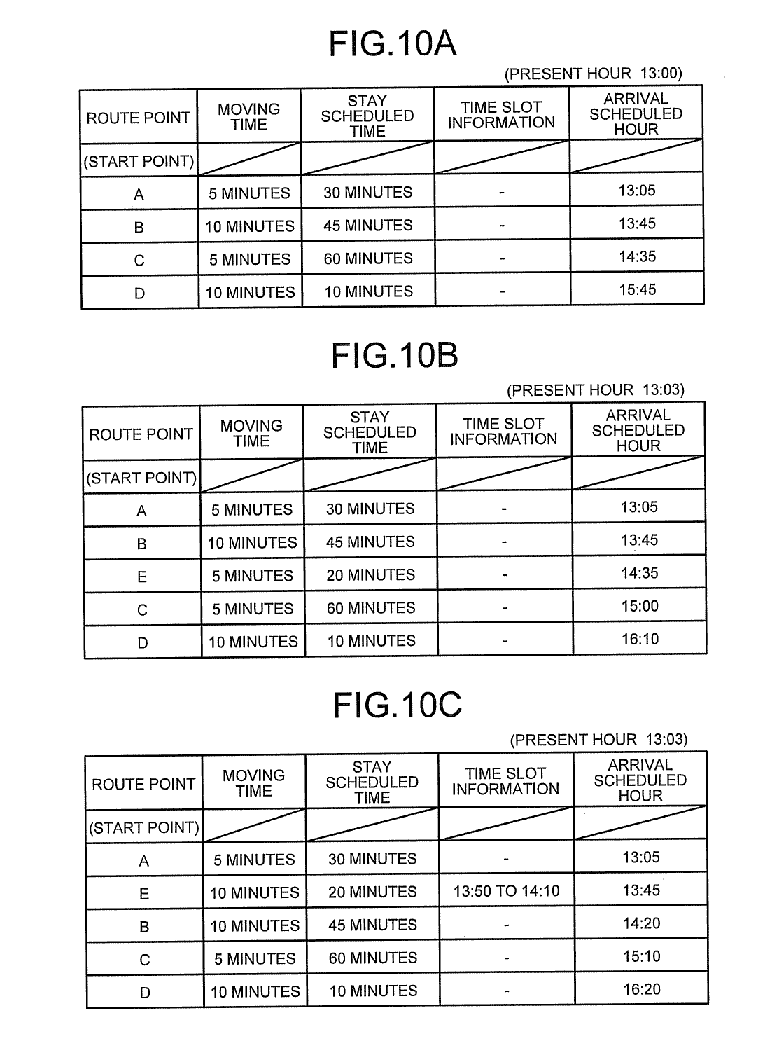

A more specific example is explained with reference to FIGS. 10 to 13.

FIGS. 10A to 10C are explanatory diagrams of a setting state of a guidance route.

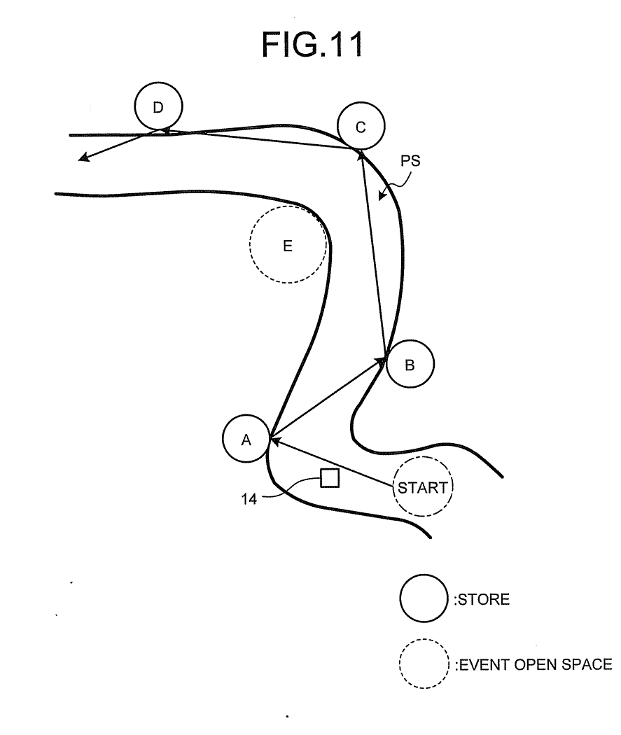

FIG. 11 is an explanatory diagram of a guidance route in an initial state.

In the following explanation, it is assumed that, at a present hour of 13:00, the user designates route points and a guidance route in the initial state is found.

As shown in FIG. 10A, it is assumed that, in the initial state, the user passes through four stores A to D as route points. It is assumed that a stay scheduled hour is set to 30 minutes for the store A, 45 minutes for the store B, 60 minutes for the store C, and 10 minutes for the store D.

As shown in FIG. 11, it is assumed that the present location of the user and the portable information terminal apparatus 13 at the hour 13:00 is a location indicated by characters “start” encircled by an alternate long and short dash line in FIG. 11. Distances from the present location to the respective stores A to D along a route PS are in a relation of A<B<C<D.

As shown in FIG. 10A, it is assumed that, in the initial state, time information (passing scheduled hours or passing scheduled time slots) is not included in information concerning the stores A to D.

As a result, the guidance route found in the initial state is simply set as a shortest route on the basis of the distances to the respective stores A to D.

As shown in FIG. 10A, an arrival scheduled hour at the store A is set to 13:05 taking into account a moving time of 5 minutes from the present location at the start of the route guidance. In this case, the moving time is set on the basis of standard walking speed (e.g., about 3 km per hour) and moving distances among the stores. The user can also register walking speed of the user in advance. The setting of these kinds of walking speed is the same in the following explanation.

An arrival scheduled hour at the store B is set to 13:45 calculated by adding 40 minutes (=30 minutes+10 minutes) to the arrival scheduled hour at the store A taking into account a stay scheduled time (30 minutes) in the store A and a moving time (10 minutes) required for movement from the store A to the store B. In the same manner, an arrival scheduled hour at the store C is set to 14:35 and an arrival scheduled hour at the store D is set to 15:45. It is assumed that data of the arrival scheduled hours is stored in the data storing section 42 of the portable information terminal apparatus 13 as basic data of a guidance route.

Under the conditions explained above, it is assumed that the user finds an interesting advertisement in the digital signage terminal apparatus 14 during walk before arriving at the store A and acquires advertisement information via the first wireless communication unit for information acquisition 47 of the portable information terminal apparatus 13.

First, in the following explanation, information concerning a route point that should be added included in the acquired advertisement information does not include time information concerning an hour or a time slot when the user should pass through the route point that should be added.

In the following explanation, the route point that should be added is the event open space E.

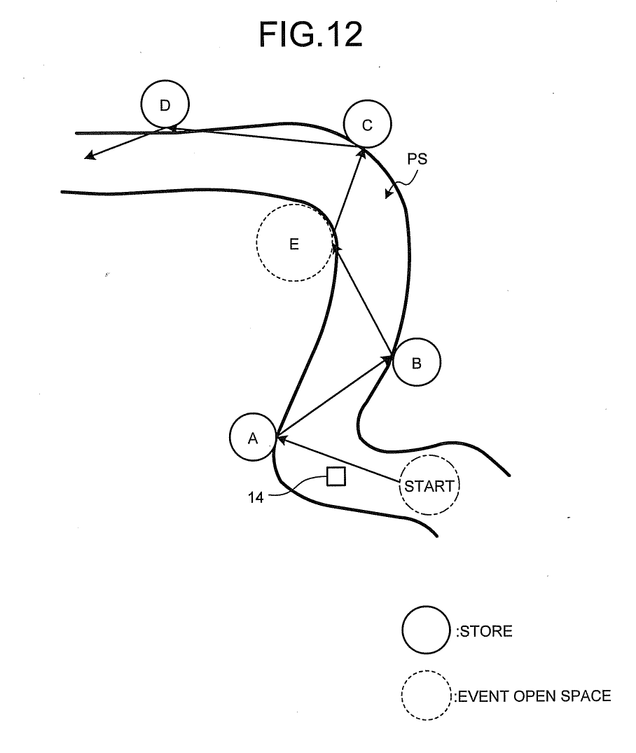

FIG. 12 is an explanatory diagram of a guidance route set if the time information concerning an hour or a time slot when the user should pass through the route point that should be added is not included in the information concerning the route point that should be added.

In this case, time information is not included in advertisement information in which the event open space E is set as a route point. Therefore, as shown in FIG. 12, a guidance route is set as a shortest route and sequentially passes through the store A, the store B, the event open space E, the store C, and the store D.

Arrival scheduled hours at the store A and the store B in this case are respectively 13:05 and 13:45 as in the initial state.

An arrival scheduled hour at the event open space E is set to 14:35 taking into account a stay scheduled time of 45 minutes in the store B and a moving time of 5 minutes from the store B to the event open space E. In the same manner, an arrival scheduled hour at the store C is set to 15:00 and an arrival scheduled hour at the store D is set to 16:10.

Therefore, after a decided hour when the user passes through the event open space E, the controller 41 performs route guidance according to hours shown in FIG. 10B.

In the following explanation, information concerning a route point that should be added included in the acquired advertisement information includes time information concerning an hour or a time slot when the user should pass through the route point that should be added.

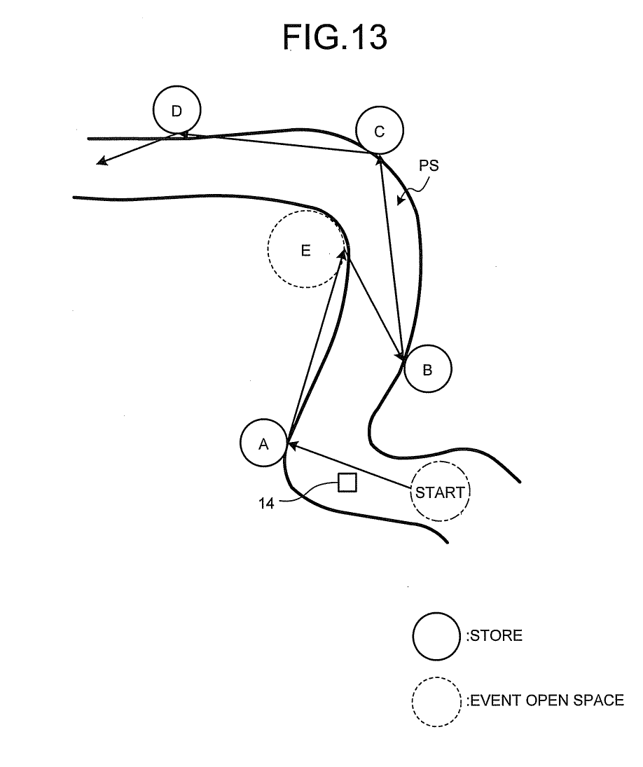

FIG. 13 is an explanatory diagram of a guidance route set if the time information concerning an hour or a time slot when the user should pass through the route point that should be added is included in the information concerning the route point that should be added.

In the following explanation, the route point that should be added is the event open space E and an event holding time slot is 20 minutes from 13:50 to 14:10.

In this case, time slot information of a time slot when the user should pass through the event open space E is included.

Therefore, as shown in FIG. 13, a guide route is set to give priority to a holding time slot of an event held in the event open space E and sequentially pass through the store A, the event open space E, the store B, the store C, and the store D.

An arrival scheduled hour at the store A in this case is set to 13:05 as in the initial state. However, the user arrives at the store B after taking part in the event held in the event open space E.

Specifically, an arrival scheduled hour at the event open space E is 13:45 immediately before the holding start hour 13:50 of the event held in the event open space E.

Therefore, the user of the portable information terminal apparatus 13 can surely take part in the event held in the event open space E.

After the end of the event, an arrival scheduled hour at the store B is set to 14:20 taking into account a moving time of 10 minutes from the event open space E to the store B. In the same manner, an arrival scheduled hour at the store C is set to 15:10 and an arrival scheduled hour at the store D is 16:20.

Therefore, after a decided hour when the user passes through the event open space E, the controller 41 performs route guidance according to hours shown in FIG. 10C.

As explained above, according to this embodiment, the portable information terminal apparatus 13 performs re-search for a guidance route on the basis of information concerning route points included in advertisement information delivered from the digital signage terminal apparatus 14, which is an advertisement information delivery terminal. Therefore, even if a route point where a time slot is specified is included or added later, it is possible to surely perform, without increasing labor of the user, route guidance such that the user passes through the route point according to the time slot.

In the above explanation, the portable information terminal apparatus 13 is configured to perform route search. However, an external apparatus such as a server on the outside may be configured to perform route search.

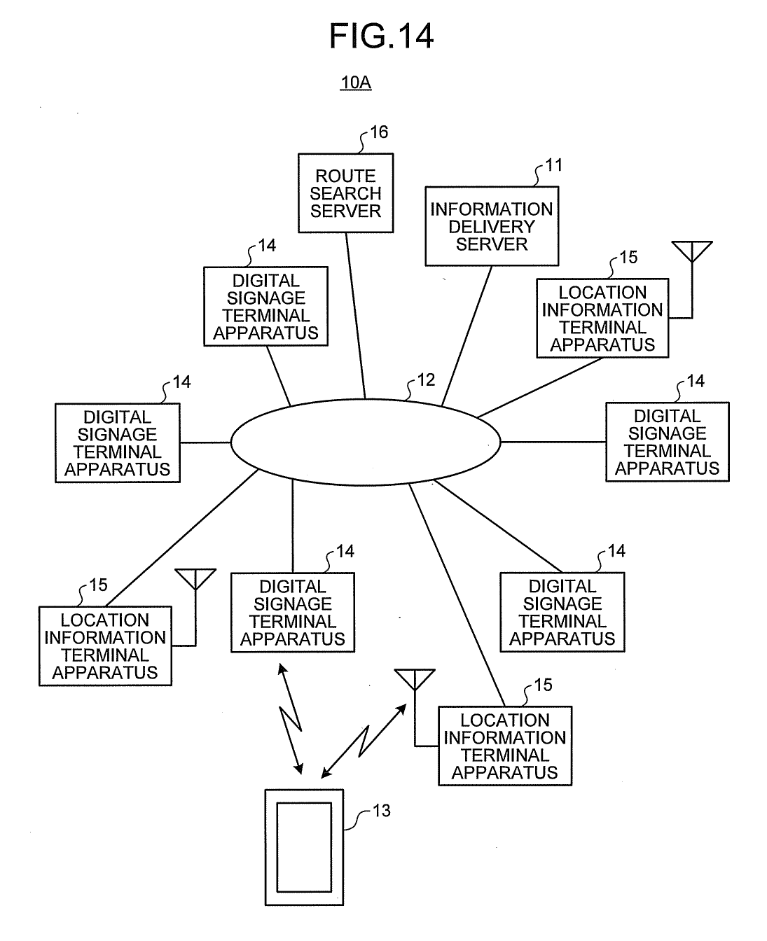

FIG. 14 is a schematic configuration block diagram of an information processing system according to another embodiment.

In FIG. 14, an information processing system 10A is different from the information processing system 10 according to the embodiment of FIG. 1 in that the information processing system 10A includes a route search server 16 as an external apparatus that performs route search.

An operation performed when a route point added to a guidance route is notified from the digital signage terminal apparatus 14 to the portable information terminal apparatus 13 in a route navigation mode is explained.

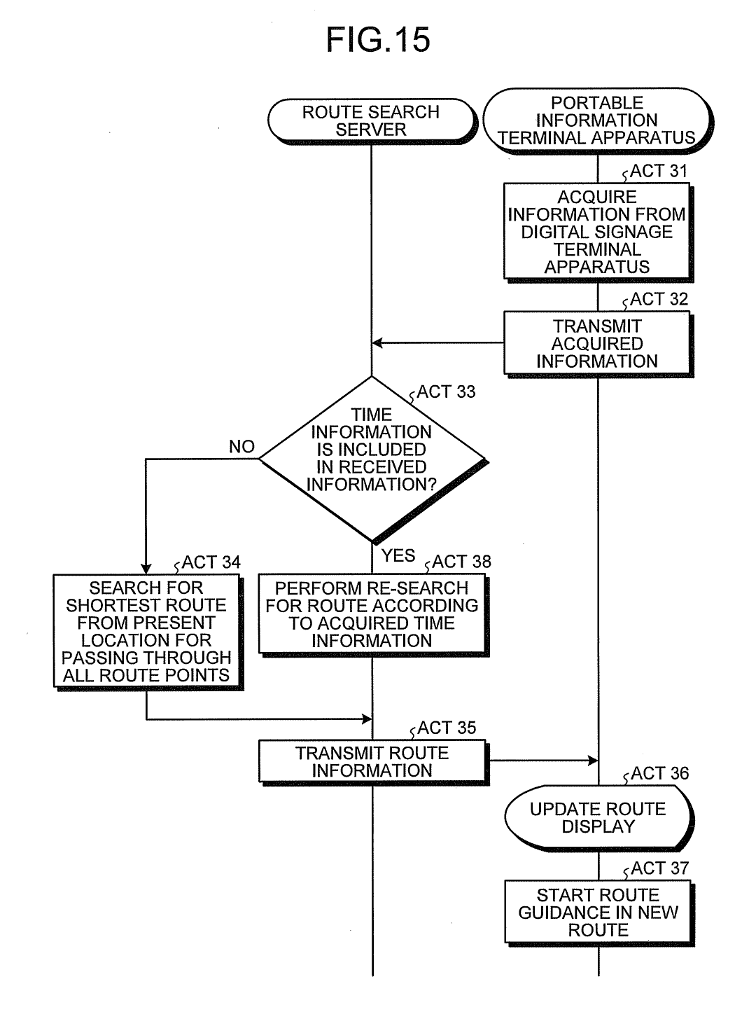

FIG. 15 is a timing chart of processing by a portable information terminal apparatus 13 and a route search server 16 performed when a route point is added.

In this case, it is assumed that the route search server 16 stores information concerning the guidance route before the addition of a route point.

As shown in FIG. 7, in a state in which a user sees and takes an interest in an advertisement and desired advertisement information including information concerning a commodity corresponding to the advertisement or a store dealing in the commodity is displayed on the display unit 21 of the digital signage terminal apparatus 14, if the user brings the portable information terminal apparatus 13 close to a communicable range of the short-range wireless communication section 23, information concerning a route point (the commodity, the place of the store, a place where an event is held, etc.) related to the advertisement information is transmitted to the portable information terminal apparatus 13. The transmitted information concerning the route point related to the advertisement information is received by the portable information terminal apparatus 13 using the first wireless communication unit for information acquisition 47.

The portable information terminal apparatus 13 receives and acquires the transmitted information concerning the route point related to the advertisement information (Act 31).

Subsequently, the controller 41 of the portable information terminal apparatus 13 notifies the route search server 16 of a route search request via the digital signage terminal apparatus 14 or via a separate wireless communication network together with the received information concerning the route point related to the advertisement information (Act 32).

The route search server 16 receives the information concerning the route point related to the advertisement information and the route search request from the portable information terminal apparatus 13. The route search server 16 discriminates whether time information (hour information or time slot information), which is information concerning an hour or a time slot when the user should arrive at the route point, is included in the acquired information concerning the route point (Act 33).

If time information is not included in the received information concerning the route point in the discrimination in Act 33 (No in Act 33), the route search server 16 searches for, as a new guidance route, a shortest route from a present location for passing through all route points including the added route point (Act 34).

The route search server 16 transmits guidance route data, which is an obtained search result, to the portable information terminal apparatus 13 (Act 35).

According to the guidance route data, the controller 41 of the portable information terminal apparatus 13 performs display update (route display update) for a guidance route in order to display the obtained guidance route on the display unit 43 (Act 36). The controller 41 starts route guidance in the new guidance route (Act 37).

On the other hand, if time information is included in the received information concerning the route point in the discrimination in Act 33 (Yes in Act 33), the route search server 16 performs re-search for a guidance route according to time information acquired such that the user can arrive at or stay at the added route point at an hour or a time slot corresponding to the time information (Act 38).

Therefore, in this case, a shortest route is not always searched for. Therefore, the route search server 16 performs re-search for a guidance route such that the user can arrive at the event site, which is the route point, before the time slot or at a time slot early enough for effectively taking part in the event.

The route search server 16 transmits guidance route data, which is an obtained search result, to the portable information terminal apparatus 13 (Act 35).

According to the guidance route data, the controller 41 of the portable information terminal apparatus 13 performs display update (route display update) for a guidance route in order to display the obtained guidance route on the display unit 43 (Act 36). The controller 41 starts route guidance in the new guidance route (Act 37).

As a result of the processing, the user can surely take part in an event, time-limited sales, or the like, which the user desires to take part in, without worrying about a time slot thereof more than necessary. In this case, since the route search server 16 performs the route search processing, it is possible to reduce a processing load of the portable information terminal apparatus 13.

In the other embodiment explained above, the information delivery server 11 and the route search server 16 are configured as separate servers. However, it is also possible to cause the same server to perform the processing.

In the above explanation, processing performed when the user leaves the guide route deliberately or accidentally is not explained. However, in such a case, as in a normal route guidance system, the controller 41 performs re-search for a route and performs route guidance such that the user can pass through scheduled route points.

In the above explanation, the stay scheduled time set in advance is not changed.

However, if a stay time (an upper limit value of a change of the stay time can be set in advance) is slightly changed taking into account, for example, a holding start hour of an event that the user should visit or a closing hour of a store (or the entire shopping mall), whereby the user can visit the event or the store as scheduled, the portable information terminal apparatus 13 can be configured to present the stay time and the holding start hour or the closing hour to the user and urge the user to change the stay time.

In the above explanation, the processing performed only if stores that the user visits are located on the same floor is explained. However, the embodiment can also be applied even if a store (or an event open space, etc.) that the user originally intends to visit and a store (or an event open space, etc.) added from the digital signage terminal apparatus 14 are located in plural floors.

For example, even if the store (or the event open space, etc.) that the user originally intends to visit is located on the first floor and the store (or the event open space, etc.) added from the digital signage terminal apparatus 14 is located on the second floor, the portable information terminal apparatus 13 can be configured to allow the user to visit the stores (or the event open spaces, etc.) in a shortest route or with priority given to time.

The control program executed by the portable information terminal apparatus 13 according to this embodiment may be provided while being recorded in a computer-readable recording medium such as a CD-ROM, a flexible disk (FD), a CD-R, or a DVD (Digital Versatile Disk) as a file of an installable format or an executable format.

The control program executed by the portable information terminal apparatus 13 according to this embodiment may be stored on a computer connected to a network such as the Internet and provided by being downloaded through the network.

The control program executed by the portable information terminal apparatus 13 according to this embodiment may be provided or distributed through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable information terminal apparatus comprising:
an information acquiring unit configured to acquire route point information corresponding to advertisement information displayed on an advertisement information delivery terminal apparatus;
a route search unit configured to search for a guidance route including a set route point and a route point equivalent to the route point information acquired by the information acquiring unit; and
a route guidance unit configured to perform route guidance on the basis of the guidance route.

2. The apparatus according to claim 1, wherein, if a new route point information is acquired by the information acquiring unit after the search for a guidance route, the route search unit adds a route point equivalent to the route point information and performs re-search for a guidance route.

3. The apparatus according to claim 1, further comprising a display unit configured to display a present location of the apparatus and the guidance route, wherein
the route guidance unit displays a guidance route including the set route point and the route point equivalent to the route point information on the display unit and performs the route guidance.

4. A portable information terminal apparatus comprising:
an information acquiring unit configured to acquire route point information corresponding to advertisement information displayed on an advertisement information delivery terminal apparatus and including location information of a route point and information concerning an arrival recommended hour when arrival at the route point is recommended;
a route search unit configured to search for a guidance route including a set route point and a route point equivalent to the route point information acquired by the information acquiring unit such that a user arrives at, at the arrival recommended hour, a route point corresponding to the information concerning the arrival recommended hour; and
a route guidance unit configured to perform route guidance on the basis of the guidance route.

5. The apparatus according to claim 4, wherein
the route point information includes information concerning a stay time slot at the route point, and
the route search unit performs re-search for the guidance route such that the user can stay at the route point in the stay time slot.

6. The apparatus according to claim 4, wherein, if a route point for which an arrival time is set is present and the route search unit determines that the user cannot arrive at the route point at the set arrival hour when the route guide unit performs the route guidance according to a guidance route already found, the route search unit performs re-search for the guidance route such that the user can arrive at the route point at the set arrival hour.

7. The apparatus according to claim 4, further comprising a display unit configured to display a present location of the apparatus and the guidance route, wherein
the route guidance unit displays a guidance route including the set route point and the route point equivalent to the route point information on the display unit and performs the route guidance.

8. The apparatus according to claim 4, wherein, if a new route point information is acquired by the information acquiring unit after the search for a guidance route, the route search unit adds a route point equivalent to the route point information and performs re-search for a guidance route.

9. A computer program product including a computer-readable recording medium including plural commands for performing a route guidance operation that can be executed by a computer, the plural commands causing the computer to execute:
an information acquiring operation for acquiring route point information corresponding to advertisement information displayed on an advertisement information delivery terminal apparatus; and
a route searching operation for searching for a guidance route including a route point equivalent to the acquired route point information.
